(19) United States
(12) Patent Application Publication
(10) Pub. No.: US 2003/0214406 A1
(43) Pub. Date: Nov. 20, 2003

(54) Cover for electronic tag and assembly thereof

(76) Inventor: Alan Epstein, Pomona, NY (US)

Correspondence Address: JORDAN AND HAMBURG LLP, 122 EAST 42ND STREET, SUITE 4000, NEW YORK, NY, 10168, US

(21) Appl. No.: 10/146,038

(22) Filed: May 14, 2002

(51) Int. Cl. G08B 13/14

(52) U.S. Cl. 340/572.8

(57) ABSTRACT

An electronic tag enclosure assembly includes an electronic tag and an enclosure having the electronic tag disposed therein. The enclosure optionally reassembles a stuffed toy or sports item. A front side defines a fastener opening through which at least one fastening device extends from the electronic tag to permit fastening to a vehicle surface. The enclosure has an entrance opening for insertion of the electronic tag. The walls of the enclosure optionally include cushioning material. Still further, the enclosure may include or have appended thereto stuffed portions to give the enclosure the appearance of the stuffed toy or sports item. The stuffed portions or cushioning material serve to provide mechanical shock protection. Additionally, the enclosure can serve to identify the electronic tag or to obscure it. Furthermore, the enclosure material serves to protect the electronic tag from the sun's rays.

### BACKGROUND OF THE INVENTION

The present invention relates to a cover for an electronic tag and, more particularly, to a cover for removably accepting an electronic tag device and permitting mounting of the electronic tag.

Electronic tags are devices which can be carried on vehicles and which permit wireless communication effecting identification of the vehicle. In particular, such electronic tag devices have been used to automate toll collection in major metropolitan areas. The electronic tag devices are typically mounted on the inside of a windshield by means of VELCRO™, generically known as loop and hook fastening materials, or similar fastening means which permit convenient removal of the electronic tag. While mounted on the windshield, the electronic tag is read when the vehicle passes through a toll area and a deduction is automatically made from the user's account. Each electronic tag includes a receiving and transmitting device, or transceiver, also referred to as a transponder, which is activated when passing through the toll and emits a signal identifying the account associated with the electronic tag.

The electronic tags must be mounted on the windshield in order to ensure proper operation. If the tags are not mounted on the windshield, but are kept on the dashboard or in some other low profile location, proper transmission of the account number may not be achieved. However, when the tags are properly mounted they are continuously exposed to the sun's rays and therefore subject to deterioration due to the sunlight. In addition, the tags are also clearly visible to pedestrians and may present an enticement to thieves. Still further, some users find the appearance of the tags objectionable, either because of the color not complementing the vehicle's interior or the utilitarian design of the tags.

When users do not wish to keep the electronic tags continuously mounted, the electronic tags are often loosely stored in the vehicle. Such storage subjects the tags to mechanical shock when the vehicle travels over poor road surface or off road which can damage electronic components within the electronic tags.

Yet another complication arises when multiple electronic tags are needed, for example, where a traveler routinely passes through tolls in different regions not having an interconnected system. If multiple tags are required, having all the tags mounted on the windshield leads to clutter and possible obstruction of vision. In such a situation, one might only mount the tag required at a given time. However, if the tags look alike in outward appearance, selection of the proper one presents a problem and possibly a hazard when one is operating a vehicle.

### SUMMARY OF THE INVENTION

Accordingly, it is an object of the invention to provide a device which covers an electronic tag and protects it from sunlight.

It is a further object of the invention to provide a cover for an electronic tag which protects the mechanical tag from mechanical shock.

It is a still further object of the invention to provide a device for identifying an electronic tag.

It is yet another object of the invention to provide a device for preventing unwanted activation of an electronic tag.

Briefly stated, the present invention provides an electronic tag assembly attachable to a vehicle surface. The electronic tag enclosure assembly includes an electronic tag and an enclosure defining a cavity having the electronic tag disposed therein. The enclosure has a front side defining a fastener opening through which at least one fastening device extends from the electronic tag to permit fastening to the vehicle surface. The enclosure further defines an entrance opening through which the electronic tag is inserted into the cavity. The enclosure may be padded, for example the walls of the enclosure optionally includes cushioning material. Still further, the enclosure may include or have appended thereto stuffed portions such that the enclosure will have the appearance of a stuffed toy, such as a Teddy Bear, or other creatures, figures or items. The stuffed portions or cushioning material serve to provide mechanical shock protection. Additionally, coloring or a configuration of the enclosure can serve to identify the electronic tag or to obscure it from public view. Furthermore, the enclosure material serves to protect the electronic tag from the sun's rays.

In accordance with these and other objects of the invention, there is provided an electronic tag assembly attachable to a vehicle surface. The electronic tag enclosure assembly includes an electronic tag having a housing with a front side with at least one fastening device for attaching the electronic tag to the vehicle surface and an enclosure defining a cavity having the electronic tag disposed therein. The enclosure has a front side defining a fastener opening through which the at least one fastening device extends to permit fastening to the vehicle surface.

According to a feature of the invention, there is further provided an entrance opening through which the enclosure is inserted. Optionally, the entrance opening has a closure device for at least partially closing the entrance opening. In one embodiment the closure device is a zipper, however, other types of closing devices may be used.

According to another feature of the invention, the fastener opening is an aperture, i.e., a closed perimeter opening. Alternatively, the fastener opening may be provided as an open ended slot communicating with the entrance opening. Additionally, any number of fastening devices may be employed provided that sufficient fastener apertures exist to permit fastening of the electronic tag assemble. It will be further realized that the fastening devices and fastening apertures need not be equal in number.

The present invention is understood to encompass embodiments which address all or only a portion of the above objects, and include all or any combination of the above features and advantages which, unless recited in claims defining the invention, are understood not to limit interpretation of such claims. The above, and other objects, features and advantages of the present invention will become apparent from the following description read in conjunction with the accompanying drawings, in which like reference numerals designate the same elements.

### BRIEF DESCRIPTION OF THE DRAWINGS

FIG. 1 is a front elevation view of an electronic tag;

FIG. 2 is a perspective environmental of the electronic tag installed in a vehicle;

FIG. 3 is a side elevation view of an embodiment of the electronic tag installed on a windshield;

FIG. 4 is a side elevation view of another embodiment of the electronic tag installed on the windshield;

FIG. 5 is a front elevation view of an embodiment of an enclosure of the present invention illustrating insertion of the electronic tag;

FIG. 6 is a side elevation view of an electronic tag assembly of the present invention showing a cross section of the enclosure having the electronic tag in an installed position;

FIG. 7 is a front elevation view of another embodiment of an enclosure of the present invention illustrating insertion of the electronic tag;

FIG. 8 is a front elevation view of still another embodiment of an enclosure of the present invention;

FIG. 9 is a front elevation view of yet another embodiment of an enclosure of the present invention;

FIG. 10 is a side elevation view of the embodiment of the electronic tag assembly of FIG. 9 showing a cross section of the enclosure having the electronic tag in an installed position;

FIG. 11 is a rear elevation view of the embodiment of the enclosure of FIG. 9; and

FIG. 12 is a front elevation view of a further embodiment of an enclosure of the present invention.

### DETAILED DESCRIPTION OF THE INVENTION

Referring to FIG. 1, there is shown an electronic tag 30, or transponder, having fasteners 35. The electronic tag 30 includes within a transmitting device which transmits an identification code to a reader unit (not shown) which functions to read the identification code. The electronic tag 30 is triggered to transmit the identification code when a receiving circuit therein receives an appropriate triggering signal from the reader unit. Other configurations of the electronic tag may be employed and remain within the scope of the present invention so long as the electronic tag functions to deliver a signal which provides for information in some manner, including simple presence of the electronic tag 30.

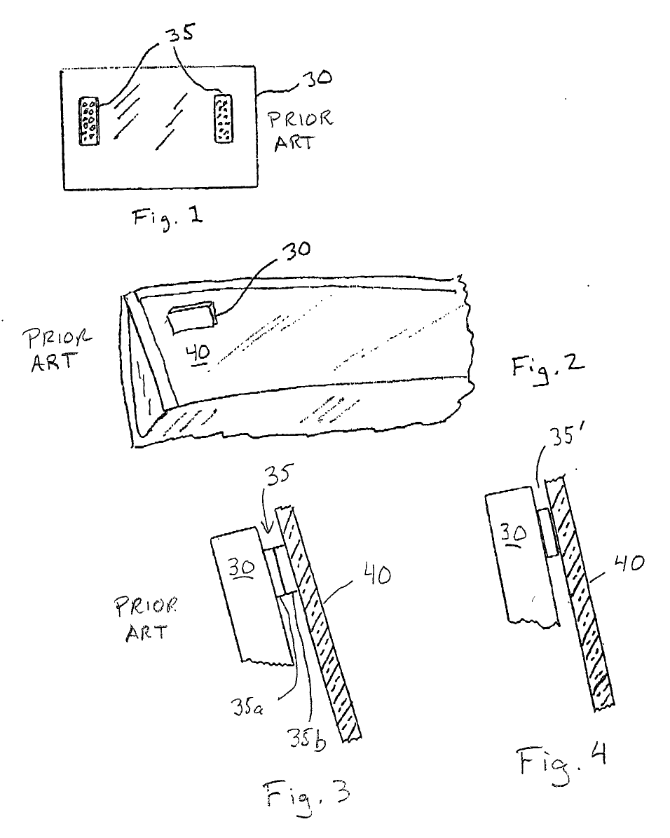

In systems wherein the electronic tag 30 is used to effect toll payment, the electronic tag 30 is mounted onto a windshield 40 as shown in FIG. 2. The exact mounting position may vary from that shown and need not be limited to the windshield. Mounting may be effected at any location permitting the electronic tag 30 to communicate with the reader unit. However, windshield mounting is preferred as this directs the electronic tag 30 at the reader unit in most instances.

Referring to FIG. 3, in order to mount the electronic tag 30 on windshield 40, the fasteners 35 in one embodiment comprise a first part 35a, which is attached to a front surface of the electronic tag 30, and a second part 35b which is adhesively fastened to the windshield 40. The first part 35a is detachably connected to the second part 35b by VELCRO™, i.e., hook and loop fastening material, or any other type of fastening arrangement which permits repeated detachment and reattachment of the first and second parts, 35a and 35b. Such fastening arrangements may include other types of mechanically interlocking devices, magnetically connecting devices, or adhesively connecting devices, so long as the function of permitting detachment and reattachment is achieved. Alternatively, a single component fastening device 35′ may be used having a detachable adhesive for connecting to the windshield 40 as shown in FIG. 4. Furthermore, the first part 35a or the single component fastening device 35′ may be integrally formed with the body of the electronic tag 30 and need not be a discrete component attached to the electronic tag 30.

Referring to FIG. 5, an enclosure 50 is provided dimensioned to accept the electronic tag 30 within an interior thereof. The interior preferably conforms to an exterior configuration of the electronic tag 30, however, such conformance is not required for the enclosure to fall within the scope and spirit of the present invention. Furthermore, the configuration of the electronic tag 30 illustrated is exemplary and the present invention is not limited to the illustrated configuration.

The enclosure 50 has an entrance opening 57 through which the electronic tag 30 is inserted. The entrance opening is optionally provided with a closure device 58 which preferably permits the entrance opening 57 to be closed and opened. In a preferred embodiment the closure device 58 is a zipper. However, the present invention is not limited to the use of a zipper or closure of the entire entrance opening 57. Other closure devices may be employed including tongue and groove zip lock devices, buttons, hooks, toggles, VELCRO™, or snaps for example. Still further embodiments of the present invention omit a closure device or provide permanent closing of the entrance opening 57.

The enclosure 50 has fastener apertures 55 defined in a front side 56 thereof which are spaced as are the fasteners 35. As shown in FIG. 6, when the electronic tag 30 is disposed within the enclosure 50, the fasteners 35 protrude through the fastener apertures 55 and permit the above noted removable attachment to the windshield 40. Alternatively, the single component fastening device 35′ may be used. Referring to FIG. 7, another embodiment has the electronic tag 30 provided with only one of the fastening devices 35 and the enclosure 50 provided with a single fastener aperture 55. It will be appreciated that the scope of the present invention is not limited to one or two fastening devices 35 and fastener apertures 55 and that a plurality may be used. Furthermore, the fastening devices 35 and fastener apertures 55 need not be equal in number as two of the fastening 35 devices may pass through a single fastener aperture 55, or vice versa.

By virtue of the fastening devices 35 extending through the fastener apertures 55 and connecting to the windshield 40, a function of holding the electronic tag 30 and the enclosure 50 together is accomplished. In an embodiment where the closure device 58 is omitted, this permits the combination of the enclosure 50 and the electronic tag 30 to be oriented on the windshield 40 with the entrance opening 57 facing upward, or sideways, in addition to the downward orientation of FIG. 6, without the enclosure 50 becoming dislodged. Accordingly, the closure device 58 is optionally used to effect closure in such embodiments and provides further protection of the electronic tag 30.

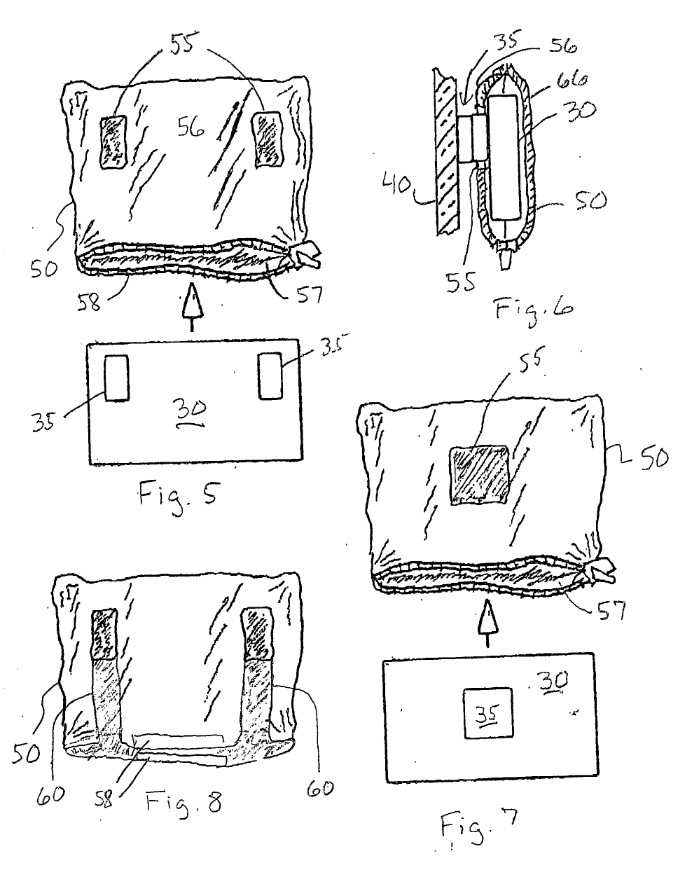

Referring to FIG. 8, another embodiment of the present invention is shown wherein the enclosure 50 is provided with fastener slots 60 in place of the fastener apertures 55. This configuration permits the enclosure 50 to be slid over the electronic tag 30 without removal of the electronic tag 30 from attachment with the windshield 40. The fastening devices 35 and fastener slots 60 need not be equal in number as two of the fastening 35 devices may pass through a single fastener slot 60, or vice versa. Again, the closure device 58 is optionally provided.

The enclosure 50 in one embodiment is formed of a fabric material having a suitable aesthetically acceptable outward appearance. The fabric is either natural or synthetic and can be woven or nonwoven. Optionally, other materials may be used to form the enclosure 50 such as pliable plastic sheet material, rubber, vinyl, rigid or semi rigid materials. The enclosure 50 may be formed by stitching, bonding, or molding the materials to define the interior of the enclosure 50. Multiple types of materials may also be used in combination. Furthermore, the material may be formed of a cushioning material or include a cushioning material to provide mechanical shock protection for the electronic tag 30, especially when loosely stored in a vehicle. For the purposes of this embodiment of the present invention, any material which permits electromagnetic transmission through the front side 56 of the enclosure 50 may be used. In another embodiment, the electronic tag may effect optical communication in which case the front side 56 will function to permit optical transmission, rather than electromagnetic transmission, either through an aperture or transparent or semitransparent material.

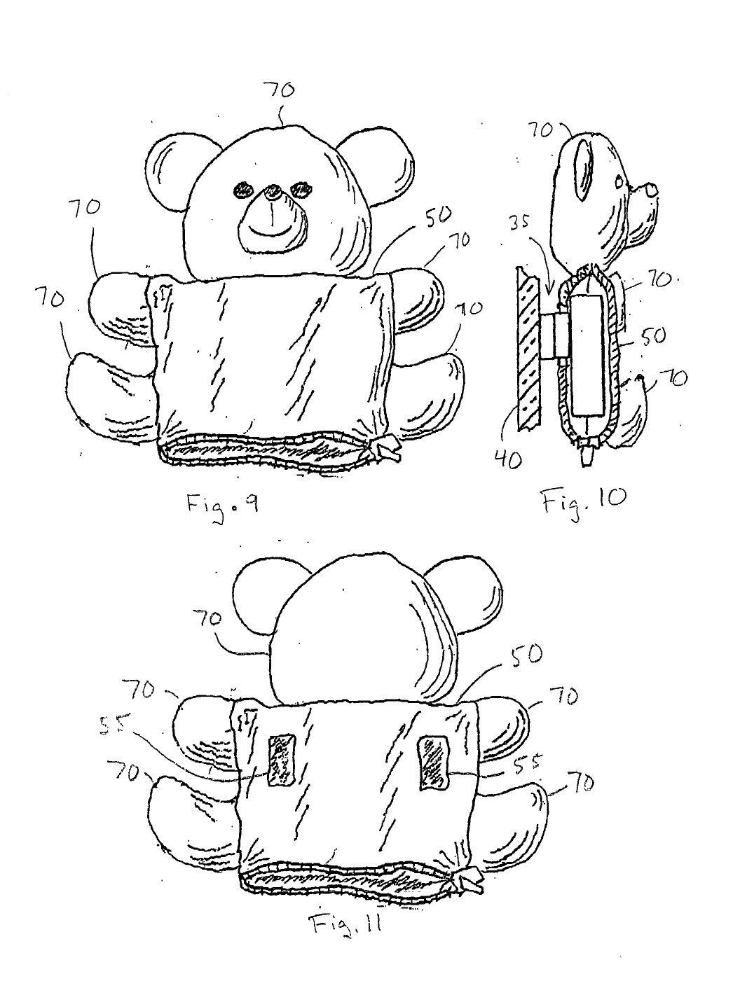

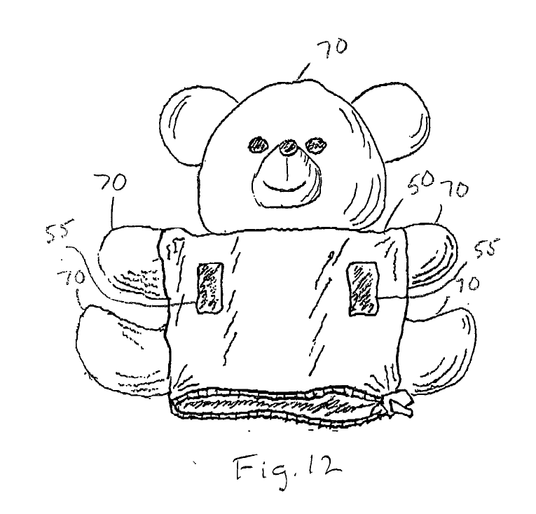

Referring to FIGS. 9-12, other embodiments of the invention are shown wherein the enclosure 50 is provided with an outer envelope configuration differing from that of the electronic tag 30. Such configurations can serve to camouflage the electronic tag 30 to divert unwanted interest therefrom. Also, such differing configuration can serve to provide for incorporation of shock absorbing materials include cushioning or padding. As shown in FIG. 9, the enclosure 50 is given the appearance of a stuffed toy animal or creature, for example, having appendages 70, such as arms, legs, and a head. Thus, the outer shape, or configuration, of the enclosure 50 differs from the rectangular outer configuration of the electronic tag 30 illustrated. The appendages 70 are preferably filled with a stuffing material which provides for cushioning and shock absorption but optionally may be simply fabric material extending from the basic body of the enclosure 50. The embodiment illustrated presents the appearance of a bear, however, it is understood that the scope of the present invention includes appearances of other creatures, figures, or items. For instance, the enclosure may be configured to resemble sport items such as a football, baseball, or basketball. Additionally, items associated with hobbies or other interests may be selected. In FIGS. 9-11, the enclosure 50 is configured to provide a toy appearance facing into the vehicle while in FIG. 12 an embodiment of the enclosure 50 is configured to provide a toy appearance facing out the windshield.

It has been found that the life of the electronic tag 30 is diminished possibly when the electronic tag 30 is exposed to emissions from cell phones used in the vehicle. This may be because the electronic tags 30 are erroneously triggered to transmit. An embodiment of the present invention therefore includes an electromagnetic barrier incorporated in a back side 66 of the enclosure to shield the electronic tag 30 from transmissions from cell phones or other electronic devices.

The present invention provides an enclosure 50 that when installed over the electronic tag 30 protects the electronic tag 30 from the sun's rays and other environmental elements which can impinge upon the electron tag 30 absent a covering. This is particularly advantageous when used in convertible vehicles.

The present invention further provides for the enclosure 50 optionally being provided in versions having differing colors or outward appearances to permit easy identification of the electronic tags within the enclosures. This is advantageous where a user must use different electronic tags at various locals. Furthermore, electronic tags are often associate with only one vehicle. Users who have multiple vehicles and do not wish to leave the tags in the vehicles will find it convenient to identify the electronic tags by virtue of the particular color or appearance of the enclosure 50 containing a particular tag and associating the enclosure 50 with a particular vehicle.

The present invention also provides for the enclosure 50 optionally including padding or cushioning material to protect the electronic tag 30 from mechanical shock. Such padding or cushioning material may be configured to provide the outward appearance of a stuffed toy, figure, or an article such as a football, baseball, or other such items.

Having described preferred embodiments of the invention with reference to the accompanying drawings, it is to be understood that the invention is not limited to those precise embodiments, and that various changes and modifications may be effected therein by one skilled in the art without departing from the scope or spirit of the invention as defined in the appended claims.

What is claimed is:

1. An electronic tag assembly, comprising:
an electronic tag having a housing with a front side with at least one fastening device for attaching said electronic tag to a vehicle surface;
an enclosure defining a cavity having said electronic tag disposed therein;
said enclosure having a front side defining a fastener opening through which said at least one fastening device extends to permit fastening to said vehicle surface; and
said enclosure defining an entrance opening through which said electronic tag is inserted into said cavity.

2. The electronic tag assembly, of claim 1, further comprising a closure device for effecting at least partial closure of the entrance opening.

3. The electronic tag assembly, of claim 2, wherein said closure device is a zipper.

4. The electronic tag assembly, of claim 2, wherein said fastener opening is an aperture.

5. The electronic tag assembly, of claim 2, wherein said fastener opening is an open ended slot extending from said entrance opening.

6. The electronic tag assembly, of claim 1, wherein said fastener opening is an aperture.

7. The electronic tag assembly, of claim 1, wherein said fastener opening is an open ended slot extending from said entrance opening.

8. The electronic tag assembly, of claim 1, wherein said enclosure includes cushioning portions.

9. An electronic tag assembly, comprising:
an electronic tag having a housing with a front side with at least one fastening device for attaching said electronic tag to a vehicle surface;
an enclosure defining a cavity having said electronic tag disposed therein;
said enclosure having a front side defining a fastener opening through which said at least one fastening device extends to permit fastening to said vehicle surface;
said fastener opening being an aperture having an endless perimeter; and
said enclosure defining an entrance opening through which said electronic tag is inserted into said cavity.

10. The electronic tag assembly of claim 9, further comprising a closure device for effecting at least partial closure of the entrance opening.

11. An electronic tag assembly, comprising:
an electronic tag having a housing with a front side with at least one fastening device for attaching said electronic tag to a vehicle surface;
an enclosure defining a cavity having said electronic tag disposed therein;
said enclosure having a front side defining a fastener opening through which said at least one fastening device extends to permit fastening to said vehicle surface;
said enclosure defining an entrance opening through which said electronic tag is inserted into said cavity; and
said fastener opening being an open ended slot extending from said entrance opening.

12. The electronic tag assembly of claim 11, further comprising a closure device for effecting at least partial closure of the entrance opening.

13. An electronic tag assembly, comprising:
an electronic tag having a housing with a front side with at least one fastening device for attaching said electronic tag to a vehicle surface, said electronic tag having an electronic tag outer configuration;
an enclosure defining a cavity having said electronic tag disposed therein, said enclosure having an enclosure outer configuration shape different from said electronic tag outer configuration;
said enclosure having a front side defining a fastener opening through which said at least one fastening device extends to permit fastening to said vehicle surface; and
said enclosure defining an entrance opening through which said electronic tag is inserted into said cavity.

14. The electronic tag assembly of claim 13, wherein said enclosure outer configuration is that of a stuffed toy.

15. The electronic tag assembly of claim 14, wherein said enclosure outer configuration is effected using shock absorbing material.

16. The electronic tag assembly of claim 14, wherein said enclosure outer configuration includes appendages comprising arms, legs, and a head.

17. The electronic tag assembly of claim 16, wherein said enclosure outer configuration is effected using shock absorbing material.

18. The electronic tag assembly of claim 13, wherein said enclosure outer configuration is that of a sports item.

19. The electronic tag assembly of claim 18, wherein said enclosure outer configuration is effected using shock absorbing material.

20. The electronic tag assembly of claim 18, wherein said enclosure outer configuration includes one of a baseball, football, basketball, and hockey puck.
